(19) United States
(12) Patent Application Publication
(10) Pub. No.: US 2025/0216563 A1
(43) Pub. Date: Jul. 3, 2025

(54) Method and System for Fast Radiation Signature Generation and Accurate Mixture Identification

(71) Applicant: CHIMAN KWAN, Rockville, MD (US)

(72) Inventor: CHIMAN KWAN, Rockville, MD (US)

(73) Assignee: Applied Research, LLC, Rockville, MD (US)

(21) Appl. No.: 18/399,041

(22) Filed: Dec. 28, 2023

(51) Int. Cl. G01T 1/36; G01T 3/00

(52) U.S. Cl. CPC G01T 1/36; G01T 3/001

(57) ABSTRACT

The present invention is to provide a System and methods for fast radiation signature generation and accurate mixture identification. In the past, remote detection of radioactive materials in mixtures using handheld or portal detectors was challenging due to low concentration, sensor noise, environmental, and other factors. The present invention presents an integrated system for fast mixture spectra generation and accurate radioactive material identification, using advanced signal processing algorithms. The signature generation and identification algorithms can be implemented by low-cost processors, making it feasible to achieve a low cost, accurate, and real-time radioactive material monitoring.

### ORIGIN OF THE INVENTION

This invention was made with Government support under contract, HM047620C0039, awarded by National Geospatial-Intelligence Agency (NGA). The Government has certain rights in this invention.

### BACKGROUND OF THE INVENTION

Remote detection of radioactive materials in mixtures using handheld or portal detectors is challenging due to low concentration, sensor noise, environmental, and other factors. The present invention presents an integrated system for fast mixture spectra generation and accurate radioactive material identification, using advanced signal processing algorithms. The signature generation and identification algorithms can be implemented by low-cost processors, making it feasible to achieve a low cost, accurate, and real-time radioactive material monitoring.

### Radiation Detectors

For radiation monitoring, there are various types of detectors including ionization chambers, silicon diode detectors, Helium 3 tubes, etc. With respect to portals, Bertin Technologies has built many detectors [Reference 1].

### Wireless Sensor Network

The radiation detectors are connected to a data processor, a Personal Computer (PC) or a Digital Signal Processor (DSP), via a wireless sensor network. There are several types of wireless sensor networks. ZigBee™ is one popular type. ZigBee™ is low cost and efficient for collecting various radiation detector signals.

CC2430 TI System-On-Chip is used as the core for hardware nodes in the ZigBee™ network. The external circuit of CC2430 is quite simple because of its powerful functions. It couples a Printed-Circuit-Board (PCB) antenna, so the system is further enhanced in power conservation. The CC2430 is a true System-On-Chip for wireless sensor networking ZigBee™/IEEE802.15.4 solutions for 2.4 GHz wireless sensor network. It combines the excellent performance of the leading CC2420 RF transceiver with an industry-standard enhanced 8051 Micro-Controller Unit (MCU), with 128 KB flash memory and 8 KB RAM. Both the embedded 8051 MCU and the radio components have extremely low power consumption. The CC2430 also includes 12-bit ADC (Analog-to-Digital Converter) with up to eight inputs and configurable resolution. Two powerful USARTs (Universal Synchronous Asynchronous Receiver Transmitter) support several serial protocols. Combined with the ZigBee™ protocol stack (Z-Stack) from Texas Instrument (TI), the CC2430 is one of the most competitive ZigBee™ solutions in the industry.

### Integrated System for Radioactive Material Identification

FIG. 1 illustrates the key steps of an integrated radioactive material identification system. The radioactive substance can have more than one type of material. Radiation detectors are distributed in a facility such as an access portal at the border. The detectors are connected to a wireless sensor network. The detectors collect the radiation levels in the facility and the signals are wirelessly transmitted to the data processor for storage and processing. Within the processor, an algorithm in a PC or a DSP generates material identification given the detector measurements. There are two key components in the data processor,
1. mixture signature spectra generation algorithm; and
2. mixture material identification algorithm.

Once the materials are identified, the radioactive material types are then displayed in a monitor for human operator visualization and decision making.

### Mixture Spectra Generation Algorithm

Illegal use of nuclear materials can cause social unrest and dangers to human lives. It is critical to stop smuggling of nuclear materials at the customs or border checkpoints. Although there are devices such as low-cost Sodium Iodide (NaI) and other high-performance detectors, they may not function well if the radioactive material concentration is low or there are several isotopes mixed.

In recent years, there are new developments in Machine Learning (ML)/Deep Learning (DL) that have great potential in enhancing the detection and classification of nuclear materials with low concentration or mixtures [References 2-5]. However, it is still challenging for several reasons:
1. ML requires a lot of training data. Fortunately, there are software simulation tools such as Gamma Detector Response and Analysis Software (GADRAS) [Reference 6] and Geant4 [Reference 7] that can be used to generate training data. However, GADRAS is limited to US government employees and contractors. Moreover, GADRAS is limited to one person per license. Geant4 is powerful but it has many functionalities that may not be needed in radioactive mixture identification. The learning curve required for Geant4 is also huge. Compared to GADRAS, Geant4 does not have user friendly interface. Simpler and license free mixture generation software will help ordinary researchers working in nuclear power plants and private medical radiation research facilities to experiment with new identification algorithms.
2. The spectral data collected by the detectors normally contain background noise and interferences. This necessitates robust algorithms for material classification.
3. There may be scenarios where multiple nuclear materials may be present, making the spectral signatures more complicated. Some spectral unmixing may be needed in order to correctly classify and estimate the relative count contributions of the different nuclear materials.

In the literature, Automated Isotope Identification and Quantification using Artificial Neural Networks by M. Kamuda [Reference 8], discussed a single isotope spectrum generation system.

### SUMMARY OF THE INVENTION

One embodiment of the present invention is to provide a method and system, which can carry out radioactive material identification in a facility using gamma and neutron detectors.

Another embodiment of the present invention involves the use of wireless networks to connect the radiation detectors with the data processor.

Another embodiment of the present invention is to use a central data processor to collect, save, and process the radiation sensor data.

Another embodiment of the present invention is to use advanced signal processing algorithms to quickly generate realistic mixture spectra under different operating conditions.

Another embodiment of the present invention is a spectra generation algorithm that can handle more than 2 or more radioactive isotopes under different operating conditions.

Another embodiment of the present invention is to adopt latest mixture identification algorithms to achieve remote and high-performance mixture identification using spectral measurements.

Another embodiment of the present invention is that the algorithms can be implemented by low-cost DSP or Field Programmable Gate Arrays (FPGA) or PCs for real-time processing.

Another embodiment of the present invention is that the identified radioactive materials can be displayed in a monitor for operator to visualize.

### BRIEF DESCRIPTION OF THE DRAWINGS

FIG. 1 illustrates the key components of an integrated radioactive material identification system.

FIG. 2 illustrates the block diagram of a multi-isotope mixture spectrum data generation framework.

FIG. 3 illustrates a dense Deep Learning (DL) model for multi-input multi-output regression.

FIG. 4 illustrates Root Mean Square Error (RMSE) values for four methods (Homogeneous dataset—NaI).

FIGS. 5(a) and 5(b) illustrate an example of test spectrum and relative count contribution estimations from the homogeneous test dataset (NaI).

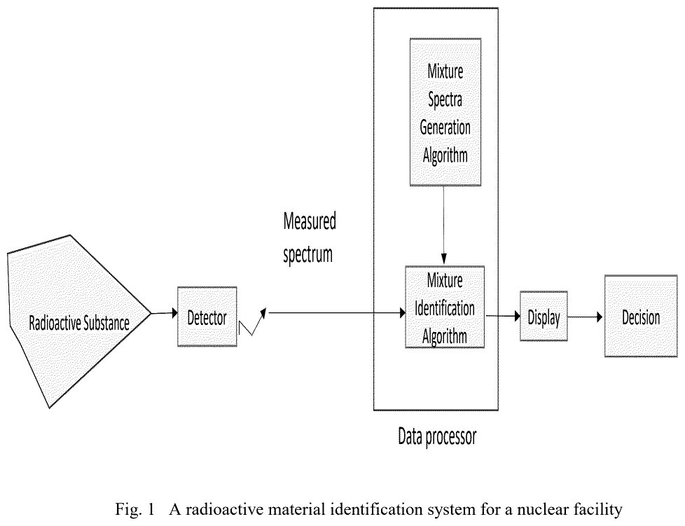

### DETAILED DESCRIPTION OF THE INVENTION

In the present invention, a new data generation framework is presented that integrates several augmentation parameters into the spectrum generation process such as integration time, background count rate, signal to background ratio, and calibration. Overall, with this new framework, one can form multi-isotope mixtures with respect to a user-set signal to background ratio and several other detector and augmentation parameters such as shielding, shielding density, etc. The output of the framework is the foreground and background spectra. Following that, the framework also generates the measured spectrum (foreground+background) by incorporating a Poisson process which creates a measured mixture spectrum from foreground and background spectra with realistic counting statistics.

The present invention is generally used for more than two isotope cases. However, a two-isotope mixture case in which one of the isotopes in the mixture is denoted by X and the other isotope is denoted by Y, is described in detail below. The measured gamma ray spectrum for this two-isotope mixture including background is then denoted by Ms. The background spectrum portion in Ms is denoted by Bs. Suppose Xs and Ys correspond to the individual spectra for the two isotopes. Ms can then be depicted as follows which is decomposed into background and the two isotopes:

$$Ms = Xs + Ys + Bs \qquad ( 1 )$$

Suppose the total number of counts for Ms is T and the mixing ratio (relative count contribution) of Xs, Ys and Bs are denoted by r_{Xs}, r_{Ys} and r_{Bs}, respectively where r_{Xs}+r_{Ys}+r_{Bs}=1. The number of count contribution for Xs, Ys and Bs can be mathematically expressed as T*r_{Xs}, T*r_{Ys} and T*r_{Bs}. Suppose Signal-to-Background Ratio is denoted by SBR. In consideration of count contributions from source and background, SBR can be mathematically expressed as:

$$\begin{matrix}SBR = Source counts / Background counts \\ \begin{matrix}= ( T * {rr}_{Xs} + T * {r}_{Ys} ) / T * {r}_{Bs} \\ = ( {r}_{Xs} + {r}_{Ys} ) / {r}_{Bs}\end{matrix}\end{matrix} \qquad ( 2 )$$

Using equation (2) above and considering r_{Xs}+Ys+r_{Bs}=1, r_{Bs} is found to be equal to 1/(SBR+1) and (r_{Xs}+r_{Ys}) is found to be equal to SBR/(SBR+1). The mixture spectrum, Ms, can be written as:

$$Ms = T * {Ms}_{1}^{norm} = T * {r}_{Xs} * {Xs}^{norm} + T * {r}_{Ys} * {Ys}^{norm} + T * {r}_{Bs} * {Bs}^{norm} \qquad ( 3 )$$

where Ms₁^{norm}, Xs^{norm} and Ys^{norm} are the normalized spectra for Ms, Xs and Ys, respectively. r_{Xs} and r_{Ys} can then be randomly selected or manually set such that the sum of them (r_{Xs}+r_{Ys}) is equal to 1−r_{Bs}.

Considering there are N two-isotope mixture spectra with M channels in the spectrum for a K isotopes pool (Xs^{norm}, Ys^{norm}, . . . , Zs^{norm}), the regression problem can be formulated as shown in equation (4) below. The modified formulation includes background, Bs^{norm}, as if it is an isotope and estimates its mixing ratio (relative count contribution).

$$[ \begin{matrix}{Ms}_{1}^{norm} \\ {Ms}_{2}^{norm} \\ … \\ {Ms}_{N}^{norm}\end{matrix} ] = [ \begin{matrix}{r}_{1}^{Xs} & {r}_{1}^{Ys} & … & {r}_{1}^{Zs} & {r}_{1}^{BGs} \\ {r}_{2}^{Xs} & {r}_{2}^{Ys} & … & {r}_{2}^{Zs} & {r}_{2}^{BGs} \\ … & … & … & … & … \\ {r}_{N}^{Xs} & {r}_{N}^{Ys} & … & {r}_{N}^{Zs} & {r}_{N}^{BGs}\end{matrix} ] [ \begin{matrix}{Xs}^{norm} \\ {Ys}^{norm} \\ … \\ {Zs}^{norm} \\ {B}^{norm}\end{matrix} ] \qquad ( 4 )$$

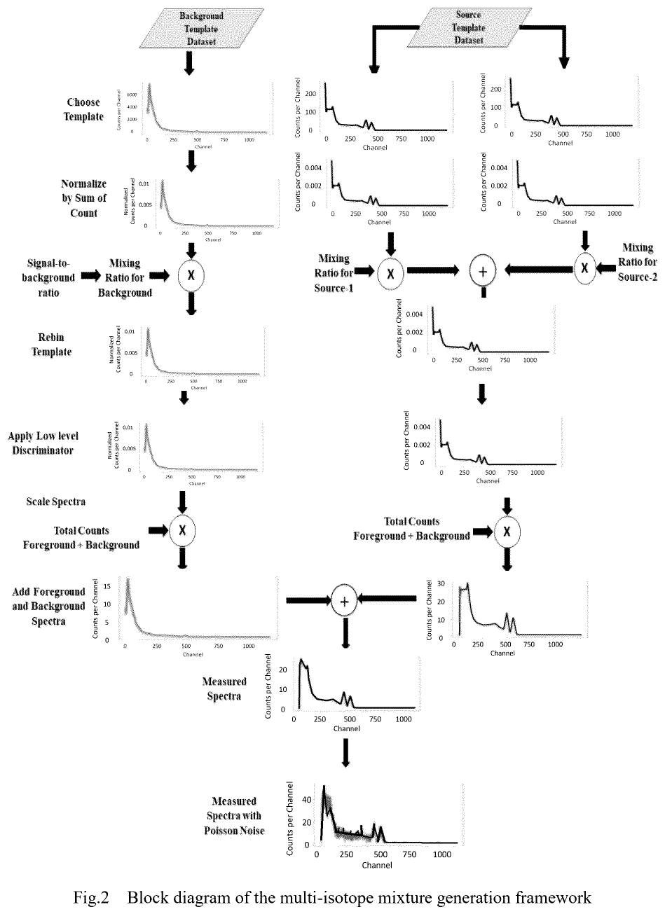

FIG. 2 shows the block diagram for multi-source mixture spectrum data generation. The block diagram is for a two-source mixture generation. However, the framework can be extended for more than two-isotope mixtures in a similar fashion. The block diagram provides the gamma ray mixture spectrum simulation processing steps. Among these processing steps:
Choose templates: Source (foreground) and background templates are chosen from the GADRAS-simulated template libraries.
Normalize templates: The chosen templates are normalized with respect to the sum of channel counts.
Assign mixing ratios: Assign the mixing ratio for background based on the user-set signal-to-background ratio. The mixing ratios for the sources/foreground are then either randomly selected or set such that the sum of the assigned mixing ratios for background and sources is equal to 1.
Form the source spectrum: Add mixing ratio multiplied source templates to form the source spectrum.
Rebin: Rebin source and background templates phase using “Calibration” parameters. The calibration parameters are used for rebinding the spectrum data according to a quadratic. The quadratic consists of three parameters. The first parameter is a constant rebinding term, which is also known as offset. The second term is a linear rebinding term, which is also known as gain. The third term is an optional quadratic rebinding term, which is also known as non-linear term. Cubic interpolation method is used to find the spectrum values at the rebined channels. This processing phase is applied to both source and background templates separately.
Apply Low-Level Discriminator (LLD) phase: This process uses the LLD parameter. It basically sets all the spectrum values at and before the set parameter LLD to 0. This process is applied to source and background templates separately.
Scale: Scale mixed-source and background spectra with total counts where total counts is equal to the sum of source counts (foreground counts) and background counts as expressed in equation (5) below. Background counts and source counts computation phase uses “Integration time,” “Background count rate” and “Signal-to-background ratio” parameters as mathematically described in equations (6) and (7) below, respectively, where background, cps corresponds to background counts per second.

total counts=source counts (foreground counts)+background counts (5)

source counts=background cps×integration time×signal to background (6)

background counts=background cps×integration time (7)
Form final measured spectra: This phase adds the source and background spectrum followed by a Poisson process to create a simulated measured spectrum with realistic counting statistics for the mixed sources and corresponding background.

### Material Identification Algorithms

Several algorithms can be used for material identification.

### 1. Partial Least Squares (PLS)

Suppose a process is modeled by

$$Y = XB + E$$

where X∈ [symbol] ^{N×m} and Y∈ [symbol] ^{N×l} are the input and output data matrices, and B∈ [symbol] ^{m×1} is a parameter matrix. Suppose X is defined as:

$$X = [ \begin{matrix}{x}_{1}^{′} \\ {x}_{2}^{′} \\ ⋮ \\ {x}_{N}^{′}\end{matrix} ] ∈ {N \times m}^{}$$

where xᵢ∈ [symbol] ^{m} is the i^{th} observation of the inputs [Reference 9]. In PLS, suppose the gamma ray spectra are denoted by X and the radioactive material compositions of X are denoted by Y. The PLS model is then based on predicting Y from X, where Y=XB; that is, PLS estimates B.

### 2. Dense Deep Learning (DDL) Model for Multi-Input Multi-Output Regression

The mixing ratio estimation performance of a DDL model for multi-input multi-output regression is examined in this investigation. The DDL model is applied to previously generated GADRAS datasets (“high-mixing-rate” and “low-mixing-rate” two-source, three-source, four-source and five-source datasets) which consist of different combinations of a total of 13 radioactive isotopes.

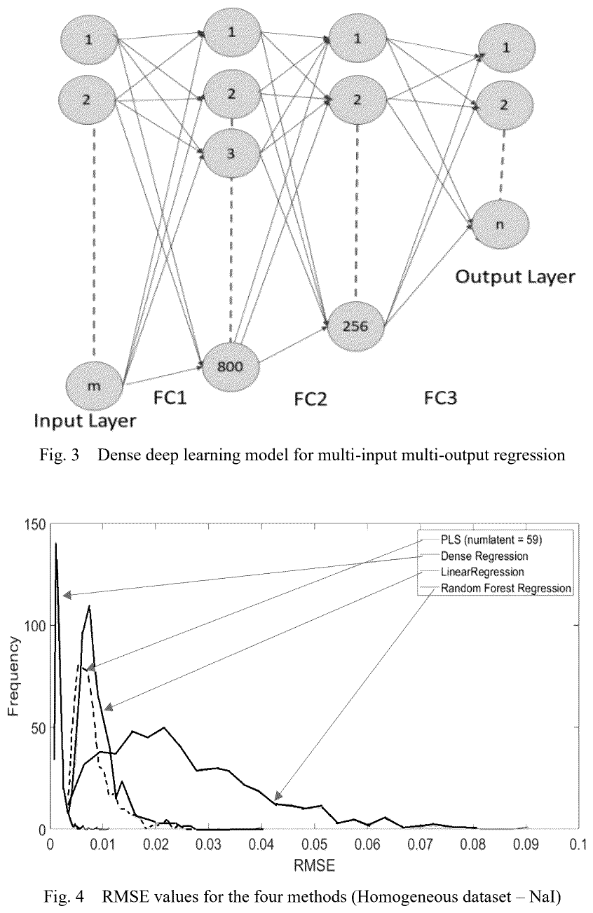

The DDL model is designed using Keras's sequential model [Reference 10]. FIG. 3 Shows the sequential model containing three Dense layers with ReLU activations. For optimization, Adam optimizer is used. After trial and error, the number of neurons in the first layer is set to 800. The number of neurons in the second layer is set to 256. The number of neurons in the third layer is set to n which is the same number of radioactive isotope materials. The DDL model is depicted in FIG. 3 as follows (in Keras script). We will call this model as “Deep Regression (DR)” in the rest of this invention.

### 3. Linear Regression (LR) and Random Forest Regression (RFR) Algorithms

We also used LR and RFR algorithms in the Keras library [10] in our investigations.

### Simulation Results

The proposed new spectra signature generation framework of the present invention is general in nature and can be applied to various operating modes. The following discusses a homogeneous scenario. That is, the augmentation parameters (such as source-to-background rate) are set to constant values, and four detector related parameters are set to constant values creating a homogeneous dataset with the exception of background variation. All generated two-isotope mixtures would have exactly the same source height, source distance, shielding and shielding density values. Other scenarios have been documented as well. To generate this homogeneous dataset, based on the user-provided signal-to-background-rate, the mixing ratio (relative count contribution) of background (rB) is computed. Then the mixing ratio of one of the two isotopes in the mixture is randomly picked to be between 0.1 and (1−rB).

Table 1 shows the set of augmentation and detector parameters used in the homogeneous dataset generation.

TABLE 1
Augmentation parameters used in homogeneous dataset generation
(NaI) with the modified mixture spectrum generation framework.

| Parameter name | Value |
|---|---|
| Background cps | 200 |
| Integration time | 1000 |
| Source to | 2 |
| background | |
| rB | 1/(source_to_background + 1) |
| rX_plus_rY | 1 − rB |
| calibration= | [0, 1, 0] |
| fwhm | 7.5 |
| rX | np.random.uniform (0.1, 1 − rB) |
| rY | rX plus rY − rX |
| rcc | [rX, rY, rB] |
| Source height | 100.0 |
| Source dist | 175.0 |
| shielding | ‘alum’ |
| Shielding density | 1.82 |

A total of 5,800 two-isotopes mixture spectra (source and background) are generated with the same detector and augmentation parameters. Among these spectra, 5,300 of them are used for training and 500 of them are used for testing. For relative count contribution estimation, the foreground spectra of the mixtures (source+background) is used, and the average RMSE values for four estimation methods are checked.

FIG. 4 shows the Root Mean Square Error (RMSE) values for 500 test spectra. Table 2 shows the average RMSE values. FIG. 4 and Table 2 demonstrate that the DR method performs better than the others by yielding lower RMSE values.

TABLE 2
Average RMSE values of the test dataset with four methods
using foreground spectra (Homogeneous dataset—NaI).

| Spectrum | | | | |
|---|---|---|---|---|
| Type | PLS | DR | LR | RFR |
| Foreground | 0.0081 | 0.0017 | 0.0092 | 0.0251 |

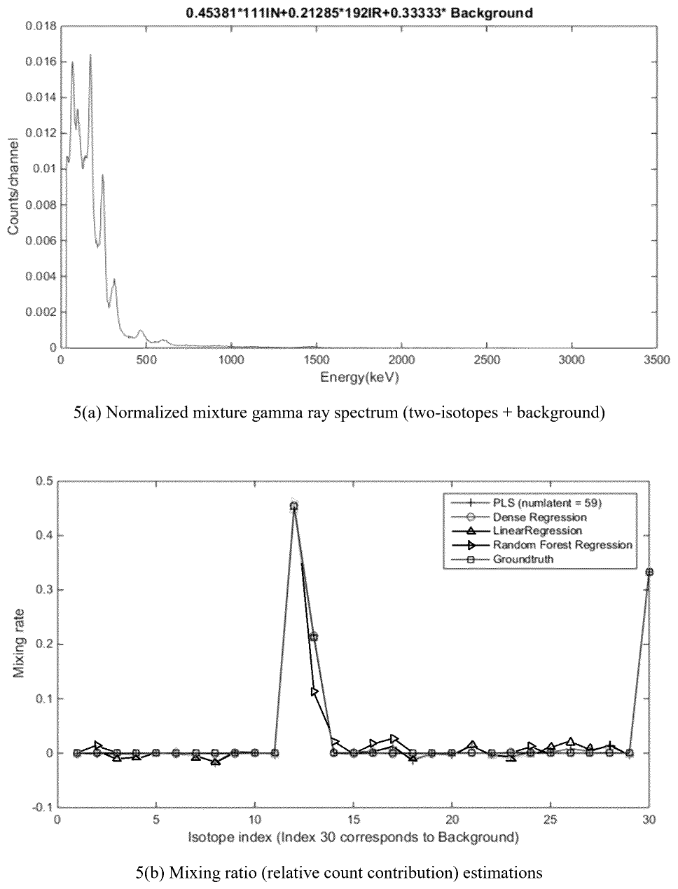

FIG. 5 demonstrates an example test spectrum together with estimated and actual mixing ratios with the four estimation methods. FIG. 5(a) shows the test spectrum containing two isotopes and background. FIG. 5(b) shows the estimated results. Two isotopes with labels 12 and 13, and the background with label 30 have been correctly identified by all the methods.

It will be apparent to those skilled in the art that various modifications and variations can be made to the system and method of the present disclosure without departing from the scope or spirit of the disclosure. It should be perceived that the illustrated embodiments are only preferred examples of describing the invention and should not be taken as limiting the scope of the invention.

### REFERENCES

[1] https://www.bertin-technologies.com/product/radiation-portal-monitors/dirad-portal-monitor/
[2] M. Durbin, A. Kuntz and A. Lintereur, “Machine Learning Applications for the Detection of Missing Radioactive Sources,” IEEE Nuclear Science Symposium and Medical Imaging Conference (NSS/MIC), Manchester, UK, 2019, pp. 1-2.
[3] G. Cordone et al., “Regression for Radioactive Source Detection,” IEEE Nuclear Science Symposium and Medical Imaging Conference (NSS/MIC), Atlanta, GA, USA, 2017, pp. 1-3.
[4] D. Kim, D. Yu, A. Sawant, M. S. Choe and E. Choi, “First experimental observation of plasma breakdown for detection of radioactive material using a gyrotron in real-time,” Eighteenth International Vacuum Electronics Conference (IVEC), London, 2017, pp. 1-2.
[5] C. Eleon, F. Battiston, M. Bounaud, M. B. Mosbah, C. Passard and B. Perot, “Study of Boron Coated Straws and mixed (10B/3He) detectors for passive neutron measurements of radioactive waste drums,” IEEE Nuclear Science Symposium and Medical Imaging Conference Proceedings (NSS/MIC), Sydney, NSW, Australia, 2018, pp. 1-4.
[6] GADRAS, osti.gov/biblio/1166695-gadras-drf-user-manual
[7] https://geant4.web.cern.ch/.
[8] M. Kamuda, Automated Isotope Identification and Quantification using Artificial Neural Networks. PhD Thesis, University of Illinois at Urbana-Champaign, 2019.
[9] B. Ayhan, C. Kwan, and G. Galbacs, “Gold Fineness Determination Using LIBS Spectra with PLS and Spectral Unmixing Techniques,” 2^{nd}. International Conference on Applied and Theoretical Information Systems Research, Taipei, 2012.
[10] Keras sequential model, keras.io/guides/sequential model/, accessed Feb. 22, 2021.

1. A radioactive material identification system comprising:
a radioactive substance detector is connected to one input of a mixture identification unit;
a muti-source mixture spectrum data generation framework is connected to another input of said mixture identification unit; wherein
said mixture spectra generation framework and said mixture identification unit are components of a data processing unit;
said data processing unit has an output connected to a display to exhibit a decision.

2. The radioactive material identification system of claim 1, wherein:
said multi-source mixture spectrum data generation framework comprising:
a background template dataset storage having a first output;
a signal to background ratio generator is connected to a background ratio mixing device to provide a second output;
said second output is combined with said first output to generate a third output;
a foreground and background total counts device is combined with said third output to form a fourth output.

3. The radioactive material identification system of claim 2, wherein:
said multi-source mixture spectrum data generation framework, further comprising:
a source template dataset storage having a first output combined with a first source mixing ratio device having a fifth output;
said source template dataset storage having a second output combined with a second mixing ratio mixing device having a sixth output;
said fifth and sixth outputs are summed together to form a seventh output;
said seventh output is combined with said foreground and background total counts device to form an eighth output; and
said fourth and eighth outputs are summed together to produce a measured spectra.

4. The radioactive material identification system of claim 1, wherein:
said radioactive substance detector comprises gamma and neutron detectors.

5. The radioactive material identification system of claim 4, wherein:
said data processing unit stores data from said gamma and neutron detectors through a wireless network.

6. The radioactive material identification system of claim 1, wherein:
said data processing unit is implemented by a low-cost Digital Signal Processor (DSP) or Field Programmable Gate Arrays (FPGA) or Personal Computer (PC) for real-time processing.

7. The radioactive material identification system of claim 1, wherein:
said mixture identification unit utilizes anyone of the following algorithms for processing:
a. Partial Least Squares (PLS);
b. Dense Deep Learning (DDL) model for multi-input multi-output regression;
c. Linear Regression (LR); and
d. Random Forest Regression (RFR).

8. A method to generate fast radiation signature and accurate mixture identification comprising the steps:
a) Choose source and background templates from a Gamma Detector Response and Analysis Software (GADRAS)-simulated template libraries.
b) Normalize said chosen templates with respect to a sum of channel counts.
c) Assign a mixing ratio for background based on a user-set signal-to-background ratio.
d) Select randomly a mixing ratio for the sources or set the mixing ratio such that the sum of said assigned mixing ratios for background and said selected mixing ratio for the sources is equal to 1.
e) Add all mixing ratio multiplied source templates to form the source spectrum.
f) Add the source and background spectrums to form measured spectrum.

9. The method to generate fast radiation signature and accurate mixture identification of claim 8, further comprising the steps:
g) Rebin source and background templates phase separately using calibration parameters.
h) Apply Low-Level Discriminator (LLD) parameter to source and background templates separately.
i) Scale mixed-source and background spectra with total counts, where total counts is expressed in equation (5) below. Source counts and Background counts computations uses “Integration time,” “Background count rate” and “Signal-to-background ratio” parameters as mathematically described in equations (6) and (7) below, respectively,
total counts=source counts (foreground counts)+background counts (5)
source counts=background cps×integration time×signal to background (6)
background counts=background cps×integration time (7)
where background cps corresponds to background counts per second.

10. The method to generate fast radiation signature and accurate mixture identification of claim 8, wherein step 8 f), further comprises the step:
Perform a Poisson process on said measured spectrum to create a simulated measured spectrum with realistic counting statistics.
